(19) United States
(12) Patent Application Publication
(10) Pub. No.: US 2002/0108123 A1
(43) Pub. Date: Aug. 8, 2002

(54) Catv system

(76) Inventors: Sel-Brian Colak, Eindhoven (NL); Petrus Augustinus Maria Van Grinsven, Eindhoven (NL); Arnold Karel Jansen Van Doorn, Eindhoven (NL)

Correspondence Address: Philips Electronics North America Corporation, Corporate Patent Counsel, 580 White Plains Road, Tarrytown, NY, 10591, US

(21) Appl. No.: 10/069,539

(22) PCT Filed: Jun. 20, 2001
(86) PCT No.: PCT/EP01/07070

(30) Foreign Application Priority Data
Jun. 27, 2000 (EP) 00202221.8

(51) Int. Cl. H04N 7/173

(52) U.S. Cl. 725/123; 725/119; 725/127

(57) ABSTRACT

The CATV system according to the invention comprises at least one primary station (2) and a plurality of secondary stations (4). The primary station (2) and the secondary stations (4) are interconnected via a hierarchical CATV network (6) comprising a plurality of nodes (8, 10, 12, 14). At least part of these nodes (8, 10, 12, 14) are redirection nodes (30) comprising redirection means (32) for redirecting data signals. The redirection means (32) may comprise a router and/or a switch. The CATV network (6) comprises, in addition to prior art CATV networks, horizontal interconnections (20) between redirection nodes (30) which are part of a same hierarchical level and/or diagonal interconnections (22) between redirection nodes (30) which are part of different hierarchical levels and different branches. These additional interconnections (20, 22) can be used for load balancing and for self-healing of the CATV network (6).

A CATV system according to the preamble is known from U.S. Pat. No. 5,841,468. Modem CATV systems can deliver a whole range of interactive services to the subscribers, such as interactive television, telephone and Internet. Each subscriber has access to the CATV system by means of a secondary station. These secondary stations are able to transmit upstream data signals via a CATV network to a primary station or head end by means of a return channel. This return channel is a frequency band which is reserved for the transmission of upstream signals (return signals). Furthermore, the primary station is able to transmit downstream data signals via the CATV network to the secondary stations. These downstream data signals may comprise television and/or video-on-demand programs, Internet data and/or telephone calls. In modem CATV systems, the CATV network most often is a hybrid fiber/coax network or HFC network.

The CATV networks of such CATV systems usually have a hierarchical structure with several hierarchical levels: the CATV system may, for example, comprise a central head end (first level) which is optically coupled to a number of hubs (second level), each hub being optically coupled to a number of fiber nodes (third level), each fiber node being coupled to a coaxial tree-and-branch network comprising a number of coaxial branches, wherein each coaxial branch comprises a number of cascaded amplifiers (fourth, fifth, etc. levels).

In the known CATV system the nodes of the CATV network comprise redirection nodes having a router/switch for redirecting upstream data signals. In this way, upstream data signals can be transmitted quickly and efficiently from a first secondary station to a second secondary station. First, such upstream data signals are transmitted by the first secondary station to a redirection node which is also coupled to the second secondary station. Second, on basis of the destination addresses contained in the upstream data signals, the upstream data signals are redirected by the redirection node to the second secondary station.

The known CATV system handles the transmission of the data signals in a relatively inflexible way.

It is an object of the invention to provide a CATV system, which handles the transmission of the data signals in a more flexible way. This object is achieved in the CATV system according to the invention, which is characterized in that the CATV network comprises horizontal interconnections between redirection nodes which are part of a same hierarchical level and/or diagonal interconnections between redirection nodes which are part of different hierarchical levels and of different branches. These horizontal and diagonal interconnections or links can advantageously be used for load balancing of upstream and/or downstream data traffic. If a default route gets congested, the links offer the possibility to redirect parts of the traffic via an alternative route (which is not overloaded) towards its destination. Moreover, the links offer redundancy in the CATV network and can even be used for self-healing purposes: if a first redirection node no longer receives data signals from a second redirection node, the redirection means of the first redirection node will no longer redirect data signals towards this second redirection node. Instead, it will redirect the data signals to another redirection node, thus providing an alternative route. Thereafter the original route can be reinstated when the first redirection node again receives data signals from the second redirection node.

An embodiment of the CATV system according to the invention is characterized in that the interconnections comprise wireless interconnections. The horizontal and diagonal interconnections or links can advantageously be formed by wireless links, e.g. wireless RF or IR links. By this measure, existing CATV systems can be upgraded relatively easy and cheap as no labor-intensive cable deployment is needed.

The above object and features of the present invention will be more apparent from the following description of the preferred embodiments with reference to the drawings, wherein:

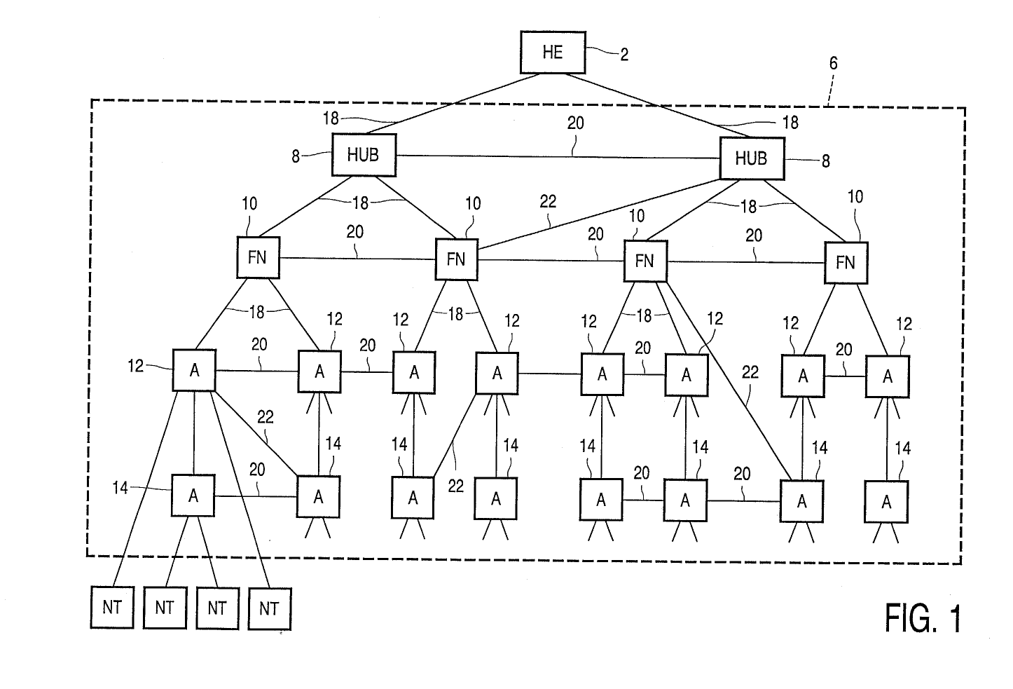

FIG. 1 shows a block diagram of an embodiment of the CATV system according to the invention,

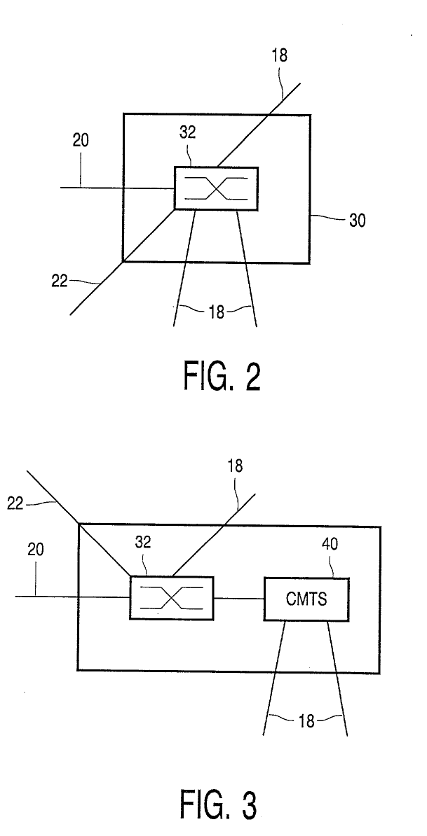

FIG. 2 shows a block diagram of a first embodiment of a redirection node for use in the inventive CATV system,

FIG. 3 shows a block diagram of a second embodiment of a redirection node which may be used in the CATV system according to the invention.

In the Figures, identical parts are provided with the same reference numbers.

The CATV system according to FIG. 1 is an interactive CATV system. The CATV system comprises a primary station or head end 2 and a plurality of secondary stations or network terminations 4. The primary station 2 and the secondary stations 4 are interconnected via a CATV network 6. The CATV network is a hybrid fiber/coax network or HFC network which comprises a plurality of nodes: hubs 8, fiber nodes 10 and coax amplifiers 12 and 14. In the embodiment shown in FIG. 1, the head end 2 is coupled to two hubs 8 via two fiber optical links 18, each hub 8 is coupled to two fiber nodes 10 via two fiber optical links 18, each fiber node 10 is coupled to two coax amplifiers 12 via two coaxial links 18, and each coax amplifier 12 is coupled to a single coax amplifier 14. Furthermore, in the embodiment of FIG. 1 there are two network terminations 4 coupled to each coax amplifier 12 and 14. The CATV system according to the invention may comprise a different number of hubs 8, fiber nodes 10, coax amplifiers 12 and network terminations 4. Furthermore, the CATV network 6 may be a HFC network in which the fiber optical and coaxial parts of the network are differently proportioned with respect to each other. The CATV network 6 may even comprise a completely fiber optical network or a completely coaxial network.

The CATV network 6 has a hierarchical tree-like structure with several hierarchical levels and several branches. In FIG. 1, a first hierarchical level is constituted by the hubs 8. Similarly, the fiber nodes 10 constitute a second hierarchical level, while the amplifiers 12 and 14, respectively, constitute third and fourth hierarchical levels, respectively. Furthermore, a first branch is constituted by the (seen from the left side of the Figure) first hub 8, first fiber node 10, first amplifier 12 and first amplifier 14. A second branch is constituted by the (seen from the left side of FIG. 1) first hub 8, first fiber node 10, second amplifier 12 and second amplifier 14. Similarly, a third branch is constituted by the (seen from the left side of the Figure) first hub 8, second fiber node 10, third amplifier 12 and third amplifier 14.

Some of the nodes 8, 10, 12 and 14 which are part of the same hierarchical level are interconnected via horizontal links 20. For example, the hubs 8 are interconnected by means of such a horizontal link 20. Furthermore, some of the nodes 8, 10, 12 and 14 which are part of different hierarchical levels and of different branches are interconnected via diagonal links 22. For example, the (seen from the left of FIG. 1) second hub 8 and second fiber node 10 are interconnected by means of such a diagonal link 22. Some of the nodes 8, 10, 12, 14, but at least those nodes which are interconnected by means of a horizontal link 20 and/or a diagonal link 22, are redirection nodes 30 (see also FIG. 2). Such redirection nodes 30 comprise redirection means 32 for redirecting, e.g. routing/switching, downstream and/or upstream data signals. In this way, the data signals can selectively be distributed over the CATV-network 6 and the capacity of the CATV network 6 is handled more efficiently.

The head end 2 may also comprise the redirection means 32 for selectively redirecting the downstream data signals so that only a part of the downstream data signals is transmitted to a certain downstream node 8, 10, 12 or 14. Again, this contributes to a more efficient handling of the (downstream) data traffic.

The horizontal links 20 and/or the diagonal links 22 may comprise wireless interconnections between a transmitter and a receiver, for example wireless RF or IR interconnections. The wireless RF links may, for example, be provided at varying frequencies, mixing LMDS, MMDS or other RF regions as necessary. The wireless IR links may, for example, be provided at wavelengths of 1550 nm or around 800-900 nm.

FIG. 2 shows a block diagram of a first embodiment of a redirection node 30 for use in the inventive CATV system. The redirection node 30 comprises redirection means 32 for redirecting the data signals. The data signals may, at least in a part of the CATV network 6, be transmitted on basis of the Internet protocol (IP). In that case, the redirection means 32 may be formed by an IP switch. Alternatively, the data signals may be transmitted on basis of the Asynchronous Transfer Mode protocol (ATM) and the redirection means 32 may be formed by an ATM switch. The implementation of (intelligent) IP and ATM switches is well known in the art. The links 18, 20 and 22 may support the transmission of downstream and upstream data signals. Downstream data signals entering the redirection node 30 via the upper link 18 may, on basis of the destination address(es) contained in the downstream data signals and on basis of the state of the network (e.g. the state of the network may indicate that there is a need for load balancing or that a certain link is congested) be redirected by the redirection means 32 either to one of the lower links 18, to the horizontal link 20 or to the diagonal link 22. Similarly, upstream data signal which enter the redirection node 30 via one of the lower links 18 may be redirected by the redirection means 32 either to the other lower link 18, to the upper link 18, to the horizontal link 20 or to the diagonal link 22. Data signals which enter the redirection node 30 via the horizontal link 20 may be redirected by the redirection means 32 either to the upper link 18, or to one of the lower links 18, or to the diagonal link 22. Data signals which enter the redirection node 30 via the diagonal link 20 may be redirected by the redirection means 32 either to the upper link 18, or to one of the lower links 18, or to the horizontal link 20. Although not shown in FIGS. 2 and 3, the redirection node 30 may be coupled to one or more further horizontal links 20 and/or one or more further diagonal links 22.

Advantageously, the data signals are transmitted in unmodulated form, i.e. baseband transmission of the actual zeros and ones, in which case the destination addresses are readily available to the redirection means 32. If the data signals are transmitted in modulated form, i.e. modulated on a RF carrier, demodulators (not shown) are needed to obtain the destination addresses from the data signals. Moreover, also modulators (not shown) may be needed to modulate the redirected data signals. In the fiber optical part of the CATV network 6 binary optical transmission may be used for transmission of the data signals. Such binary optical transmission is relatively robust to optical transmission impairments and is an example of the above mentioned baseband transmission.

FIG. 3 shows a block diagram of a second embodiment of a redirection node 30 which may be used in the CATV system according to the invention. This second embodiment of the redirection node 30 comprises an interface unit 40 to interface with a (coaxial) part of the CATV-network in which modulated data signals are transmitted. This interface unit 40 could, for example, be based upon a Cable Modem Termination System or CMTS as known from the DOCSIS standards. Alternatively, the interface unit 40 may be based upon a Interactive Network Adapter or INA as disclosed in the DVB-RC standard. The interface unit 40 interfaces between a baseband part of the CATV network 6, i.e. the part of the CATV network 6 in which unmodulated baseband signals are transmitted over the interconnections 18, 20 and 22, and the RF part of the CATV network 6, i.e. the part of the CATV network 6 in which RF modulated signals are transmitted over the interconnections 18. These latter interconnections 18 may be logical channels, which may be based on a single physical link, and which logical channels are part of a point to multipoint connection between the interface unit 40 and a number of network terminations 4. One of the tasks of the interface unit 40 is to take care of routing the local data traffic (i.e. upstream RF modulated data signals that have a destination address on the downstream link of the same interface unit 40) and forward all other traffic to the next node in the CATV network 6.

The scope of the invention is not limited to the embodiments explicitly disclosed. The invention is embodied in each new characteristic and each combination of characteristics. Any reference signs do not limit the scope of the claims. The word “comprising” does not exclude the presence of other elements or steps than those listed in a claim. Use of the word “a” or “an” preceding an element does not exclude the presence of a plurality of such elements.

1. A CATV system comprising at least one primary station (2) and a plurality of secondary stations (4), the primary station (2) and the secondary stations (4) being interconnected via a CATV network (6), the CATV network (6) comprising a plurality of nodes (8, 10, 12, 14), wherein at least part of the nodes (8, 10, 12, 14) are redirection nodes (30) comprising redirection means (32) for redirecting data signals, and wherein the CATV network (6) has a tree-like hierarchical structure with several hierarchical levels and several branches, characterized in that the CATV network (6) comprises horizontal interconnections (20) between redirection nodes (30) which are part of a same hierarchical level and/or diagonal interconnections (22) between redirection nodes (30) which are part of different hierarchical levels and of different branches.

2. A CATV system according to claim 1, characterized in that the interconnections (20, 22) comprise wireless interconnections.

3. A CATV system according to claim 2, characterized in that the wireless interconnections comprise wireless RF interconnections.

4. A CATV system according to claim 2, characterized in that the wireless interconnections comprise wireless IR interconnections.

5. A CATV system according to any one of the preceding claims, characterized in that the CATV network (6) comprises a HFC network.

6. A CATV network (6) comprising a plurality of nodes (8, 10, 12, 14), wherein at least part of the nodes (8, 10, 12, 14) are redirection nodes (30) comprising redirection means (32) for redirecting data signals, and wherein the CATV network (6) has a hierarchical structure with several hierarchical levels, characterized in that the CATV network (6) comprises horizontal interconnections between redirection nodes (30) which are part of a same hierarchical level and/or diagonal interconnections (22) between redirection nodes (30) which are part of different hierarchical levels and of different branches.
